(19) United States
(12) Patent Application Publication
(10) Pub. No.: US 2006/0283900 A1
(43) Pub. Date: Dec. 21, 2006

(54) Low cost adjustable and removable cross rail

(75) Inventor: Craig A. Stapleton, St. Clair, MI (US)

Correspondence Address: Warn, Hoffmann, Miller & LaLone, P.C., P.O. Box 70098, Rochester Hills, MI, 48307, US

(73) Assignee: Magna International Inc., Aurora (CA)

(21) Appl. No.: 11/154,740

(22) Filed: Jun. 16, 2005

(51) Int. Cl. B60R 9/00

(52) U.S. Cl. 224/325; 224/330

(57) ABSTRACT

Cargo rack systems for a motor vehicle are provided. The systems include cross rail members that are operable to be easily removed from and/or fastened to the side rail members and/or adjustable along the length of the side rail members. The side rail members are provided with channels formed on a top surface thereof that are operable to receive a locking mechanism that cooperates with the cross rail members. Stop members formed on the underside of a stanchion portion prevents undesired movement of the locking mechanism. When the locking mechanism is manipulated in a first direction, the cross rail member is secured to the side rail member. When the locking mechanism is manipulated in a second opposite direction, the cross rail member can either be moved to a different position along the length of the side rail member, or if desired, can be completely disengaged from the side rail member.

### FIELD OF THE INVENTION

The present invention generally relates to a cargo rack for motor vehicles and more specifically to cargo rack systems for a motor vehicle including cross rail members that are operable to be easily removed from and/or fastened to the side rail members and/or adjustable along the length of the side rail members.

### BACKGROUND OF THE INVENTION

Cargo racks for motor vehicles are generally well known in the art. Many vehicles have cargo racks comprising frames and/or rails on their exterior surfaces, such as their roof, on which luggage or other cargo can be placed for transport. Typically, such cargo racks include strips or rails on which the cargo is placed to prevent the cargo from directly contacting the vehicle surface to prevent damage thereto and/or to spread the load of the cargo over a larger area of the vehicle surface to prevent deformation of vehicle body panels. Further, cargo racks typically provide some mechanism, such as surrounding rails, tie downs and/or enclosures to prevent undesired movement of the cargo on the surface and to keep the cargo on the cargo rack while the vehicle moves.

Most conventional roof rack systems with adjustable cross rails have complex latching and unlatching mechanisms (e.g., involving a great deal of components) for the release and lock-into-place feature of the adjustable cross rails. These mechanisms are costly, not very user friendly, not as structurally sound as they should be, and do not work as well as the end user would prefer. Additionally, most of the current systems do not hold the load as well as they should during spiked or panic stops of the vehicle. For example, the load and cross rails can shift forward along the roof rack side rails creating a safety concern.

Additionally, two recurring problems with factory installed cross rail systems are that they create wind noise and they reduce vehicle fuel efficiency when they are not in use. This is due to the cross rail cross section and the rail being in the wind stream over the vehicle at all times. Current factory installed cross rail systems are not readily removable from the side rails so they can be stowed until needed. Current designs require costly covers to be removed and secondary operation loading notches added to the side rails for cross rail installation and removal.

Therefore, there exists a need for new and improved cargo rack systems, especially new and improved cross rail members that are operable to be easily removed from and/or fastened to the side rail members and/or adjustable along the length of the side rail members.

### SUMMARY OF THE INVENTION

It is an object of the present invention to provide a new and improved cargo rack system for motor vehicles which obviates at least one disadvantage of the prior art.

It is an object of the present invention to provide cargo rack systems for a motor vehicle including cross rail members that are operable to be easily removed from and/or fastened to the side rail members and/or adjustable along the length of the side rail members.

More specifically, the present invention provides a cargo rack system that is easy to operate by the user, can be easily installed, removed and/or reinstalled, can be easily adjusted for varying length loads, and can lock positively into location to avoid any load shifting along the rack side rails during use.

In accordance with a first embodiment of the present invention, a cross rail system for a cargo rack system of a vehicle is provided, comprising: (1) a cross rail member; (2) a stanchion portion operably associated with at least one end of the cross rail member; (3) a side rail member having a channel formed in a surface thereof; and (4) a fastening system operable to fasten the stanchion portion to the side rail member, wherein the fastening system is operable to be at least partially received in the channel and rotate in a first direction so as to secure the cross rail member to the side rail member.

In accordance with a second embodiment of the present invention, a cross rail system for a cargo rack system of a vehicle is provided, comprising: (1) a cross rail member; (2) a stanchion portion operably associated with at least one end of the cross rail member; (3) a side rail member, the side rail member having a channel formed in a surface thereof and a knurled portion formed on a surface thereof; and (4) a fastening system operable to fasten the stanchion portion to the side rail member, the fastening system having a knurled portion formed on a surface thereof, wherein the fastening system is operable to be at least partially received in the channel and rotate in a first direction so as to secure the cross rail member to the side rail member, wherein the knurled portion of the fastening system and the knurled surface of the side rail member are operable to engage one another.

In accordance with a third embodiment of the present invention, a cross rail system for a cargo rack system of a vehicle is provided, comprising: (1) a cross rail member; (2) a stanchion portion operably associated with at least one end of the cross rail member; (3) a side rail member, the side rail member having a channel formed in a surface thereof and a knurled portion formed on a surface thereof; (4) a fastening system operable to fasten the stanchion portion to the side rail member, the fastening system having a knurled portion formed on a surface thereof; and (5) a rotation limitation system formed on a surface of the stanchion portion, wherein the fastening system is operable to be at least partially received in the channel and rotate in a first direction so as to secure the cross rail member to the side rail member, wherein the knurled portion of the fastening system and the knurled surface of the side rail member are operable to engage one another, wherein the rotation limitation system is operable to prevent rotation of the fastening system.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an illustration of a partial perspective view of a cargo rack system for a vehicle, in accordance with the general teachings of the present invention;

FIG. 2 is an illustration of an elevational view of a side rail member, in accordance with a first embodiment of the present invention;

FIG. 3 is an illustration of an elevational view of an alternative side rail member, in accordance with a second embodiment of the present invention;

FIG. 4 is an illustration of a partial top plan view of an alternative cargo rack system, in accordance with a third embodiment of the present invention;

FIG. 5 is an illustration of a partial sectional view of the cargo rack system depicted in FIG. 4, in accordance with a third embodiment of the present invention;

FIG. 6 is an illustration of a partial exploded view of the cargo rack system depicted in FIG. 4, in accordance with a third embodiment of the present invention;

FIG. 7 is an illustration of a partial cut-away view of the cargo rack system depicted in FIG. 4, in accordance with a third embodiment of the present invention;

FIG. 8 is an illustration of a partial perspective view of the cargo rack system depicted in FIG. 4 being secured in place by a securing device, in accordance with a third embodiment of the present invention;

FIG. 9 is an illustration of a partial perspective view of a second alternative cargo rack system, in accordance with a fourth embodiment of the present invention; and

FIG. 10 is an illustration of a partial perspective view of a third alternative cargo rack system, in accordance with a fifth embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

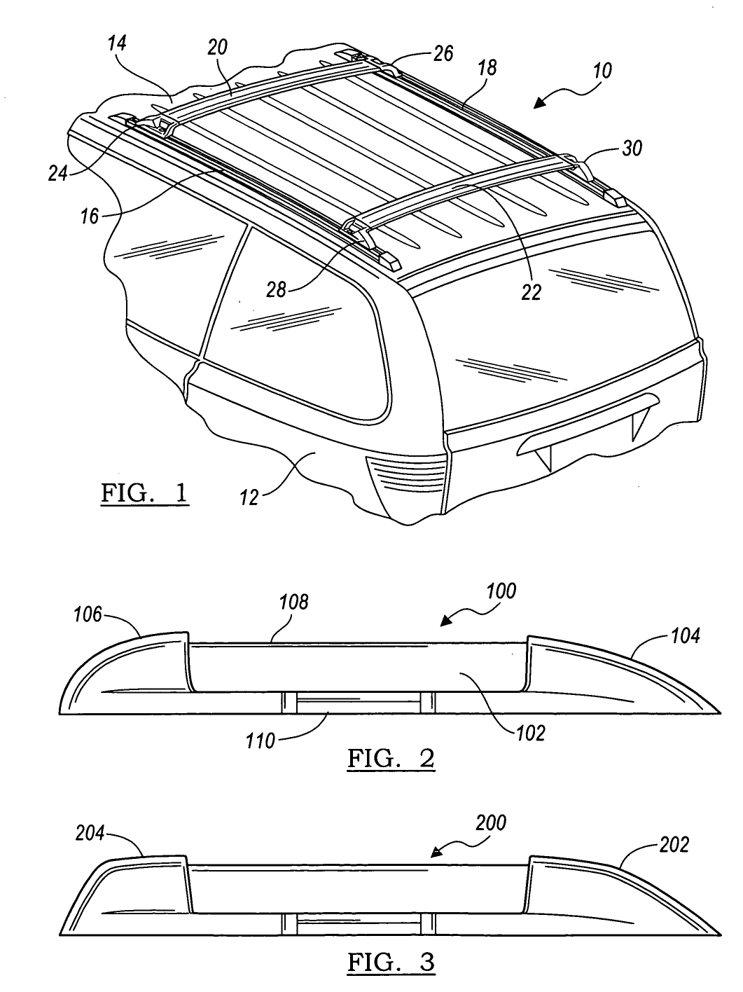

Referring to FIG. 1, there is shown a cargo rack system generally at 10 for a vehicle 12. System 10 is intended to be mounted to a roof portion 14 of the vehicle 12; however, it is envisioned that system 10 can be employed in other locations and/or applications.

System 10 includes at least one side rail member and more preferably at least two spaced and opposed side rail members 16, 18, respectively, extending along each side of roof portion 14. At least one and more preferably at least two spaced and opposed cross rail members 20, 22, respectively, independently engage each of side rail members 16, 18, respectively. Each of cross rail members 20, 22, respectively, have at least one and more preferably at least two stanchion portions 24, 26, 28, 30, respectively, formed on each end portion thereof. Stanchions portions 24, 26, 28, 30, respectively, can be integrally formed with cross rail members 20, 22, respectively, or conversely can be formed separately and then fastened, either permanently or temporarily, thereto. Stanchion portions 24, 26, 28, 30, respectively, are preferably operable to engage, either permanently or temporarily, side rail members 16, 18, respectively, as will be explained herein.

Referring to FIG. 2, there is shown a side rail member generally at 100. Side rail member 100 includes a body section 102 and two spaced and opposed end cap members or stanchion portions 104, 106, respectively. In this view, both of end cap members 104, 106, respectively, include a gradually sloping side profile, e.g., sloping towards the roof portion of the vehicle. By way of a non-limiting example, end cap portions 104, 106, respectively, are operable to close off the ends of side rail member 100 and add a styling feature to the overall assembly. By way of another non-limiting example, end cap members 104, 106, respectively, can be attached to each end of side rail member 100 with molded in snaps.

A channel portion 108 is formed on a top surface of side rail member 100, the purpose of which will be explained herein. An optional pad member 110 can be provided on a bottom surface of side rail member 100, e.g., in proximity to or adjacent to the roof portion of the vehicle. By way of a non-limiting example, pad member 110 can be formed of an extruded or molded isolator placed between side rail member 100 and the roof portion of the vehicle, e.g., to protect the paint finish. By way of another non-limiting example, pad member 110 can be attached to side rail member 100 with double back tape, molded in snaps, and/or the like.

Referring to FIG. 3 there is shown an alternative side rail member generally at 200. Side rail member 200 is essentially identical to side rail member 100 depicted in FIG. 2 in most respects. However, the difference lies in the fact that the two spaced and opposed end cap members or stanchion portions 202, 204, respectively, are shaped differently. By way of a non-limiting example, end cap member 202 has a relatively blunt side profile, while end cap member 204 has a substantially smoothly sloping side profile, e.g., sloping towards the roof portion of the vehicle.

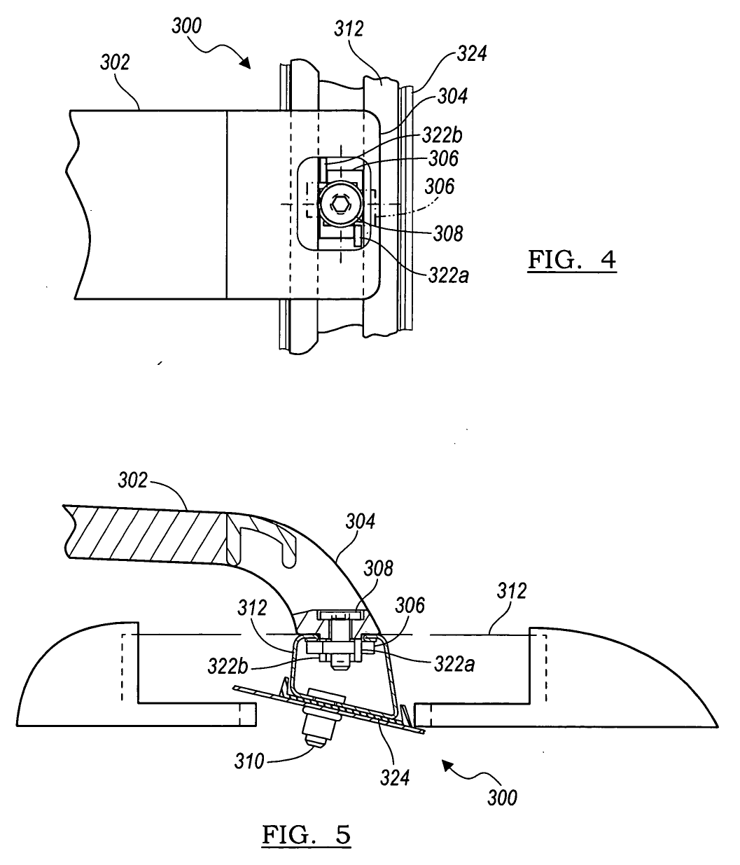

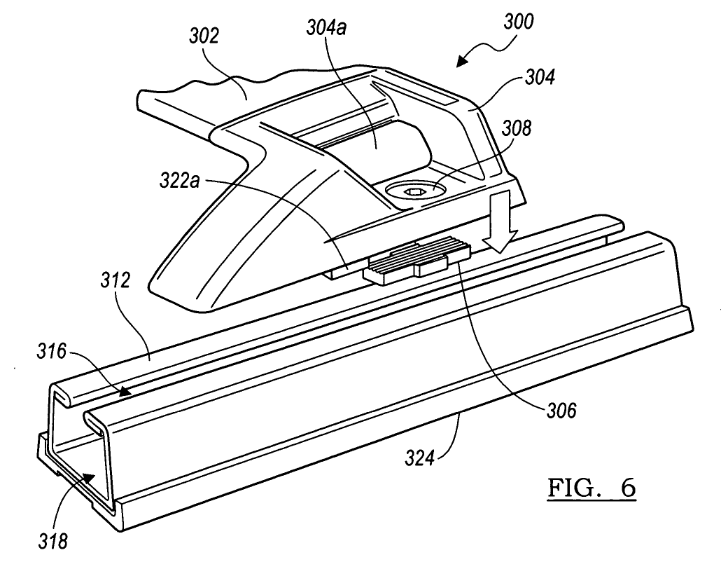

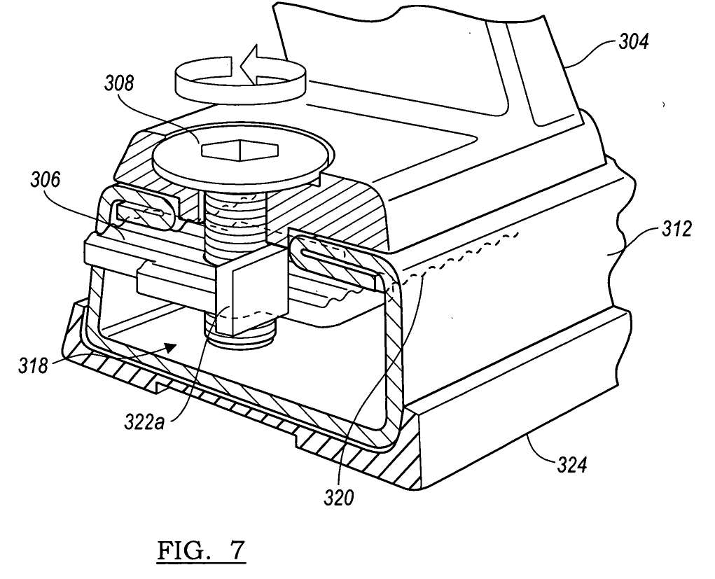

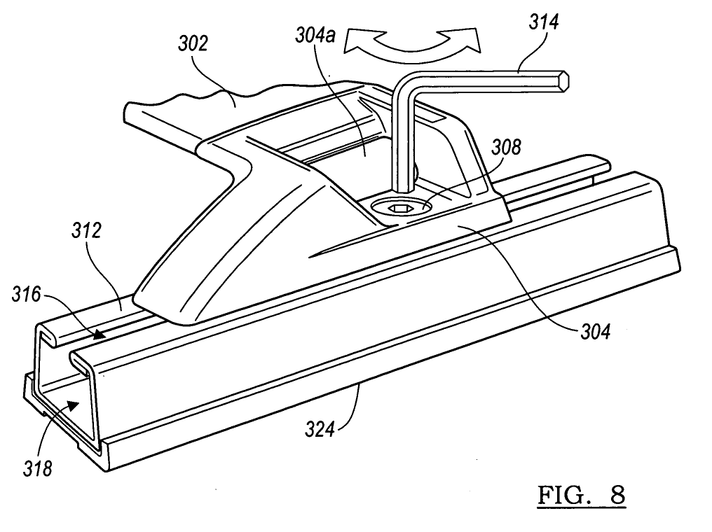

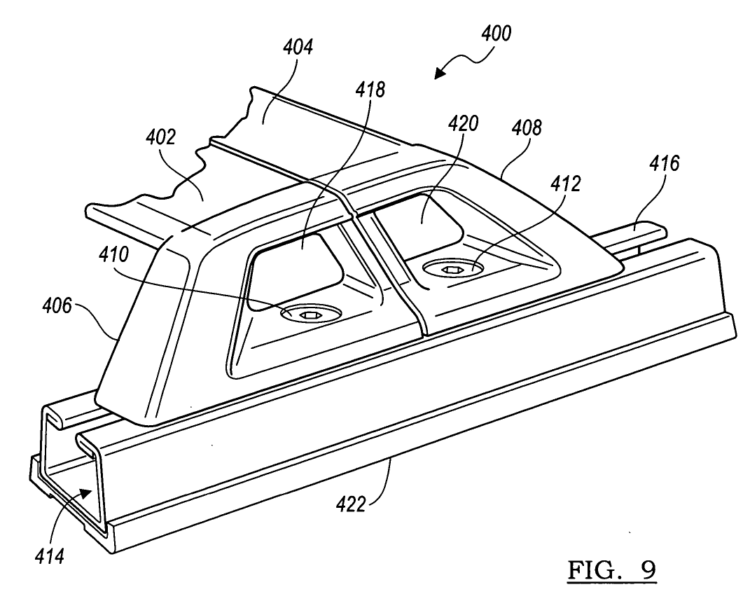

Referring to FIGS. 4-8, there is shown an alternative cargo rack system generally at 300. System 300 is similar to the system 10 depicted in FIG. 1; however, only selected portions of system 300 will be referred to in FIGS. 4-8. However, it should be noted that each cross rail members will preferably include two stanchion portions that engage independently two spaced and opposed side rail members, such as those found on a roof portion of a vehicle.

System 300 includes at least one (and more preferably at least two) cross rail member 302 having at least one (and more preferably at least two) end stanchion portion 304, at least one (and more preferably at least two) knurled lock plate member 306, at least one (and more preferably at least two) locking screw 308, and at least one (and more preferably at least two) fastening member 310, such as but not limited to a screw to be operable to attach stanchion portion 304 to a side rail member 312.

Cross rail member 302 is preferably comprised of an aerodynamic, structural load bearing section. The section incorporates all of the known best practices in the industry to eliminate potential wind noise (e.g., texture paint, trip beads, elliptical contours, and/or the like). Cross rail member 302 is preferably mechanically fastened to stanchion portion 304.

Stanchion portion 304, lock plate member 306, and locking screw 308 comprise the stanchion subassembly. The stanchion portion 304 is operably associated with locking screw 308 that is accessible from the top surface thereof such that the user can employ a tool 314 (e.g., screwdriver, hex driver, Allen wrench, and/or the like) to unlock and relocate cross rail member 302 and relock cross rail member 302 into the desired position relative to the length of side rail member 312. Stanchion portion 304 can also be provided with an optional tie loop portion 304a.

Locking screw 308 moves lock plate member 306 up and down in a “T” slot 316 formed in a channel 318 of side rail member 312. When locking screw 308 is loosened in stanchion portion 304, lock plate member 306 drops away from a knurled undersurface 320 of side rail member 312, thus allowing cross rail member 302 to slide to the desired location. Thus, side rail member 312 can also be referred to as a “slide” rail member, in that it allows slidable movement of cross rail member 302 along its length.

By way of a non-limiting example, lock plate member 306 is generally rectangular in shape. However it should be noted that other configurations are envisioned as well. The maximum width is preferably narrower than the opening of “T” slot 316 of side rail member 312 so that lock plate member 306 can be easily removed from “T” slot 316. The bottom portion of stanchion portion 304 has at least two stop tabs 322a, 322b, respectively, extending down to limit the rotational movement of lock plate member 306.

The threads of locking screw 308 have a sealant or patch to create threading resistance into lock plate member 306. When locking screw 308 is loosened, and lock plate member 306 disengages from knurled undersurface 320 of “T” slot 316 of side rail member 312, it will turn or rotate, for example, 90 degrees (or more than or less than) with locking screw 308 until the lock plate member 306 rotation is stopped by the stop tabs 322a, 322b, respectively, extending out of the bottom surface of stanchion portion 304. These stop tabs 322a, 322b, respectively, position lock plate member 306 in line with “T” slot 316 and allows cross rail member 302 to be removed by simply lifting it straight up or reinstalling it by simply loading the assembly down into “T” slot 316.

When locking screw 308 is tightened, the knurled portion of lock plate member 306 engages knurled undersurface 320 of side rail member 312. It is the interlocking of these two surfaces that positively lock cross rail member 302 into location when tightened down. This feature prevents the cross rail member 302 from shifting when loaded and a panic stop occurs. By way of a non-limiting example, when locking screw 308 is tightened, the patch on the threads rotates the lock plate member 306 from the “install position” to the “clamping position” and then draws lock plate member 306 up securely against knurled undersurface 320 of side rail member 312 “T” slot 316 and locks cross rail member 302 in location. The rotation of lock plate member 306 is limited by the two downward standing stop tabs 322a, 322b, respectively, molded into the bottom surface of stanchion portion 304. These stop tabs 322a, 322b, respectively, correctly position lock plate member 306 for either removal or clamping. Optionally, the end of locking screw 308 is disrupted after assembly to prevent cross rail member 302 from being easily disassembled from side rail member 312.

Cross rail member 302 is structural so that it can be used as either a flush mount (e.g., totally down on the roof surface) or as a raised side rail (e.g., suspended above the roof and supported only at the ends and center). The side rail section is designed to be an exposed rail so that finish changes can alter the appearance.

The attachment system of the present invention (e.g., lock plates, locking screws, and the like) to the vehicle is preferably concealed down inside side rail member 312. Access is preferably achieved through “T” slot 316 at the top of side rail member 312. This feature eliminates the need for additional components such as covers or caps to hide the attachment system. Additionally, there are no fasteners required to assemble the side rail assemblies.

Additionally, an optional pad member 324 can be employed between the bottom surface of side rail member 312 and the roof portion of a vehicle.

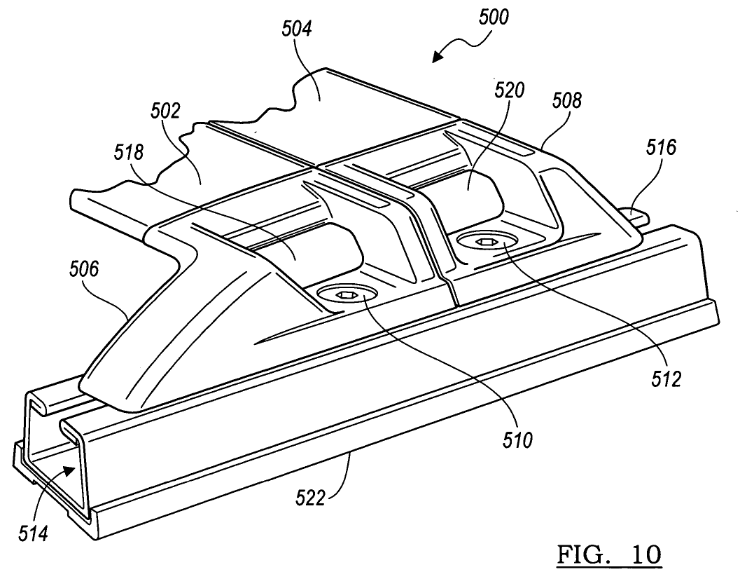

Referring to FIG. 9, there is shown a second alternative cargo rack system generally at 400. System 400 is similar to the previously described embodiments, however it differs in that two cross rail members 402, 404, respectively, having two stanchion portions 406, 408, respectively, are employed. Stanchion portions 406, 408, respectively, are shown as being substantially identical with respect to their side profile slopes.

Additionally, two locking screws 410, 412, respectively, are used (along with corresponding lock plate members (not shown) via a “T” slot 414 to secure cross rail members 402, 404, respectively, to a side rail member 416. Furthermore, optional tie loop portions 418, 420, respectively, can be provided in stanchion portions 406, 408, respectively. An optional pad member 422 can also be provided.

It should be appreciated that system 400 can be comprised of two separate cross rail members or can be comprised of an integral cross rail system that include two cross rail members (e.g., by molding, gluing, welding, fastening and/or the like).

Referring to FIG. 10, there is shown a third alternative cargo rack system generally at 500. System 500 is very similar to system 400 in that it includes two cross rail members 502, 504, respectively, having two stanchion portions 506, 508, respectively, are employed. However, in this embodiment, stanchion portions 506, 508, respectively, are shown as being substantially dissimilar with respect to their side profile slopes. For example, stanchion portion 506 is shown as being gradually sloped whereas stanchion portion 508 is shown as being abruptly sloped.

As with system 400, two locking screws 510, 512, respectively, are used (along with corresponding lock plate members (not shown)) via a “T” slot 514 to secure cross rail members 502, 504, respectively, to a side rail member 516. Furthermore, optional tie loop portions 518, 520, respectively, can be provided in stanchion portions 506, 508, respectively. An optional pad member 522 can also be provided.

As with system 400, it should be appreciated that system 500 can be comprised of two separate cross rail members or can be comprised of an integral cross rail system that include two cross rail members (e.g., by molding, gluing, welding, fastening and/or the like).

It should be appreciated that any of the features and characteristics of the various aforementioned embodiments can be used in conjunction with one another in any number of combinations.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A cross rail system for a cargo rack system of a vehicle, comprising:
a cross rail member;
a stanchion portion operably associated with at least one end of the cross rail member;
a side rail member having a channel formed in a surface thereof; and
a fastening system operable to fasten the stanchion portion to the side rail member;
wherein the fastening system is operable to be at least partially received in the channel and rotate in a first direction so as to secure the cross rail member to the side rail member.

2. The invention according to claim 1, wherein the fastening system comprises a fastening member, wherein the fastening member is operable to be received within an area defining an aperture formed in the stanchion portion.

3. The invention according to claim 2, wherein the fastening system comprises a plate member, wherein the plate member is operable to be at least partially received in the channel.

4. The invention according to claim 3, wherein the plate member includes a knurled portion formed on a surface thereof.

5. The invention according to claim 4, wherein the side rail member includes a knurled portion formed on a surface thereof.

6. The invention according to claim 5, wherein the knurled portion of the plate member and the knurled surface of the side rail member are operable to engage one another.

7. The invention according to claim 1, wherein the fastening system is operable to rotate about 90 degrees within the channel.

8. The invention according to claim 1, wherein the fastening system is operable to rotate in a second direction so as permit the cross rail member to disengage from the side rail member.

9. The invention according to claim 1, further comprising a rotation limitation system formed on a surface of the stanchion portion.

10. The invention according to claim 9, wherein the rotation limitation system comprises at least one tab member.

11. The invention according to claim 10, wherein the at least one tab member is operable to prevent rotation of the fastening system.

12. A cross rail system for a cargo rack system of a vehicle, comprising:
a cross rail member;
a stanchion portion operably associated with at least one end of the cross rail member;
a side rail member, the side rail member having a channel formed in a surface thereof and a knurled portion formed on a surface thereof; and
a fastening system operable to fasten the stanchion portion to the side rail member, the fastening system having a knurled portion formed on a surface thereof;
wherein the fastening system is operable to be at least partially received in the channel and rotate in a first direction so as to secure the cross rail member to the side rail member;
wherein the knurled portion of the fastening system and the knurled surface of the side rail member are operable to engage one another.

13. The invention according to claim 12, wherein the fastening system comprises a fastening member, wherein the fastening member is operable to be received within an area defining an aperture formed in the stanchion portion.

14. The invention according to claim 13, wherein the fastening system comprises a plate member, wherein the plate member is operable to be at least partially received in the channel.

15. The invention according to claim 14, wherein the plate member includes a knurled portion formed on a surface thereof.

16. The invention according to claim 12, wherein the fastening system is operable to rotate about 90 degrees within the channel.

17. The invention according to claim 12, wherein the fastening system is operable to rotate in a second direction so as permit the cross rail member to disengage from the side rail member.

18. The invention according to claim 12, further comprising a rotation limitation system formed on a surface of the stanchion portion.

19. The invention according to claim 18, wherein the rotation limitation system comprises at least one tab member.

20. The invention according to claim 19, wherein the at least one tab member is operable to prevent rotation of the fastening system.

21. A cross rail system for a cargo rack system of a vehicle, comprising:
a cross rail member;
a stanchion portion operably associated with at least one end of the cross rail member;
a side rail member, the side rail member having a channel formed in a surface thereof and a knurled portion formed on a surface thereof;
a fastening system operable to fasten the stanchion portion to the side rail member, the fastening system having a knurled portion formed on a surface thereof; and
a rotation limitation system formed on a surface of the stanchion portion;
wherein the fastening system is operable to be at least partially received in the channel and rotate in a first direction so as to secure the cross rail member to the side rail member;
wherein the knurled portion of the fastening system and the knurled surface of the side rail member are operable to engage one another;
wherein the rotation limitation system is operable to prevent rotation of the fastening system.

22. The invention according to claim 21, wherein the fastening system comprises a fastening member, wherein the fastening member is operable to be received within an area defining an aperture formed in the stanchion portion.

23. The invention according to claim 22, wherein the fastening system comprises a plate member, wherein the plate member is operable to be at least partially received in the channel.

24. The invention according to claim 23, wherein the plate member includes a knurled portion formed on a surface thereof.

25. The invention according to claim 21, wherein the fastening system is operable to rotate about 90 degrees within the channel.

26. The invention according to claim 21, wherein the fastening system is operable to rotate in a second direction so as permit the cross rail member to disengage from the side rail member.

27. The invention according to claim 21, wherein the rotation limitation system comprises at least one tab member.
